(19) United States
(12) Patent Application Publication
(10) Pub. No.: US 2002/0104613 A1
(43) Pub. Date: Aug. 8, 2002

(54) System and method for a rotatable sleeve device

(76) Inventor: Stephen M. Key, Modesto, CA (US)

Correspondence Address: CARR & FERRELL LLP, 2225 EAST BAYSHORE ROAD, SUITE 200, PALO ALTO, CA, 94303, US

(21) Appl. No.: 10/112,542

(22) Filed: Mar. 27, 2002

Related U.S. Application Data
(63) Continuation-in-part of application No. 09/551,985, filed on Apr. 15, 2000, now Pat. No. 6,402,872.
(63) Continuation-in-part of application No. 09/126,010, filed on Jul. 29, 1998, now Pat. No. 6,086,697.
(63) Continuation-in-part of application No. 09/866,219, filed on May 25, 2001.
(63) Continuation of application No. 09/273,232, filed on Mar. 18, 1999, now Pat. No. 6,237,269.
(60) Provisional application No. 60/279,236, filed on Mar. 27, 2001.

(51) Int. Cl. B32B 31/00

(52) U.S. Cl. 156/268; 156/229; 156/294; 156/308.4; 156/182; 156/84

(57) ABSTRACT

A system and method are disclosed for constructing a rotatable sleeve device. The rotatable sleeve device includes a sleeve disposed about a container, preferable positioned and held in place by at least one surface contour. In one embodiment, the sleeve is made of a rigid, but flexible material. The sleeve is formed with expansion joints such that the joints allow the sleeve to expand over the surface contour of the container in order to position the sleeve about the container or to remove the sleeve from the container. The rotatable sleeve further includes at least one transparent region which permits viewing of an underlying subset of indicia disposed on an inner label or directly on the container.

### CROSS-REFERENCES TO RELATED APPLICATIONS

This application claims the benefit of Provisional Patent Application Serial No. 60/279,236 filed on Mar. 27,2001, entitled “Rotatable Sleeve System and Method,” which is incorporated herein by reference. Additionally, this application is a is a continuation-in-part of commonly assigned patent application Ser. No. 09/551,985 filed on Apr. 15, 2000 entitled “Rotating Label System and Method”, which is a continuation-in-part of U.S. Pat. No. 6,086,697 entitled “Rotating Label System and Method”. Further, this application is a continuation-in-part of application Ser. No. 09/866,219 filed on May 25, 2001 entitled “Roll-Fed Method for Constructing a Rotatable Label System”, which is a continuation of U.S. Pat. No. 6,237,269 entitled “Roll-Fed Method for Constructing a Rotatable Label System”. All of these applications and patents are hereby incorporated by reference.

The present application is further related to and incorporates by reference the following patents and patent applications: U.S. Pat. No. 5,809,674 issued Sep. 22, 1998 for an invention entitled “Apparatus and Method for Increasing an Effective Information Carrying Surface Area on a Container”; U.S. Pat. No. 5,884,421 issued Mar. 23, 1999 entitled “Apparatus and Method for Constructing a Rotatable Label Device”; U.S. Pat. No. 6,129,802 issued on Oct. 10, 2000 entitled “Rotatable Label System and Method of Constructing Same”; and patent application Ser. No. 10/005,428 entitled “Rotating Label System and Method”.

### BACKGROUND OF THE INVENTION

1. Field of the Invention

The present invention relates generally to labels and more particularly to a rotatable sleeve device for a container.

2. Description of Related Art

Many consumer product containers are labeled with various types of information. This information may include, for example, product directions for use, warnings, ingredients, advertisements, company logos, and artwork. Such information is typically presented on a label wrapped around the container or disposed directed on an exterior surface of the container.

A problem associated with conventional containers is that insufficient space is available on the exterior surface of the container to display all of the information desired to a consumer. In order to accommodate all of the desired information on the exterior surface of the container, a manufacturer may reduce font size of the indicia. Further, the indicia may be more closely spaced together. However, the reduction in size of text and/or graphics may adversely affect the visual appeal of the container, and may render some or all of the information illegible to the consumer.

A manufacturer who desires to convey a relatively large amount of information may place some of the information on a separate sheet of paper (known as an insert) packaged with the container. However, the insert is frequently lost or discarded after the initial use of an associated product of the container, thus causing information set forth thereon to be unavailable to a user at a later time.

Therefore, there is a need for a system for increasing the amount of information that can be presented on a container. There is a more specific need for a rotatable sleeve system having an augmented surface area for presenting written and graphical information, and which can be easily mounted on the container.

### SUMMARY OF THE INVENTION

The present invention overcomes or substantially alleviates prior problems associated with display of information on a container. In general, the present invention provides a container having an inner label or written indicia disposed directly thereon and a rotatable outer sleeve of a firm material, such as paper, plastic, film, or other material with a stiff or rigid quality, but which is still flexible.

The rotatable sleeve preferably includes at least one transparent region or an opening (i.e., die-cut) which, when rotated relative to the container about a central vertical axis thereof, allows selective viewing of co-located indicia arranged on an exterior surface of the container (either on the inner label affixed to the container or printed directly on the exterior surface of the container). Because indicia may be disposed both on the inner label or container and on the sleeve, a manufacturer may advantageously provide a substantially increased amount of information to a consumer.

The present invention further discloses various methods of constructing a rotatable sleeve system on a container. According to one embodiment, the sleeve is manufactured flat and die-cut to a preferred size. Then, the flat sleeve is formed into an annular sleeve. Ends of the sleeve may be coupled together and secured by using adhesive. Then, the annular sleeve is slid over a surface contour on the container. The sleeve is held in place either by the surface contour located below the sleeve, a surface contour above the sleeve, a taper of the container, or any combination thereof. However, the sleeve is loose enough about the container so that the sleeve may be rotated about the container. The sleeve, although rigid in form, is also expandable (due in part to expansion joints) or flexible to accommodate for the surface contour on the container. Additionally, the container, itself, may be manufactured of a flexible material. Because of the flexibility of the sleeve (and possible the flexibility of the container) and design of the container, the sleeve may be easily applied to and removed from about the container.

Accordingly, the present invention provides a rotatable sleeve device that may be efficiently constructed, and which permits written indicia disposed on the container or inner label to be viewed through a transparent region on the rotatable sleeve. Additionally, the present invention provides a considerable increase in available surface area for presentation of written indicia on the container. Other advantages and features of the present invention will be apparent from the drawings and detailed description as set forth below.

### BRIEF DESCRIPTION OF THE DRAWINGS

FIG. 1A is a front view of an exemplary flat sleeve, according to the present invention;

FIG. 1B is the sleeve of FIG. 1A formed into a annular sleeve;

FIG. 2A is an exemplary container, according to the present invention;

FIGS. 2B-2E are further embodiments of the surface contours of FIG. 2A;

FIG. 3A is a perspective view of the annual sleeve of FIG. 1B and the container of FIG. 2A with the sleeve partially advanced over the container;

FIG. 3B is a perspective view of the annual sleeve of FIG. 1B rotatably mounted on the container of FIG. 2A;

FIG 3C is a perspective view of the annual sleeve of FIG. 3B rotated relative to the container;

FIG. 4A is a front view of an alternative embodiment of a sleeve;

FIG. 4B is a perspective view of the sleeve of FIG. 4A rotatably mounted on a container;

FIG. 4C is a perspective view of the sleeve of FIG. 4A rotated relative to the container;

FIG. 5 is a side view of an alternative embodiment of a container and sleeve system, according to the present invention;

FIG. 6 is a side view of a further alternative embodiment of a container, according to the present invention;

FIG. 7A is a front view of an alternative embodiment of a rotatable sleeve, according to the present invention;

FIG. 7B is a front view of the sleeve of FIG. 7A provided on a roll;

FIG. 7C is a perspective view of the sleeve of FIG. 7A disposed about a container;

FIG. 8A is a front view of a further embodiment of a rotatable sleeve;

FIG. 8B is a perspective view of the sleeve of FIG. 8A disposed about a container;

FIG. 9A is a front view of yet a further embodiment of a rotatable sleeve;

FIG. 9B is a perspective view of the sleeve of FIG. 9A disposed about a container;

FIG. 9C is a perspective view of the sleeve of FIG. 9A heat-shrunk about the container;

FIG. 10A is a front view of a further embodiment of a rotatable sleeve; and

FIG. 10B is a perspective view of the rotatable sleeve of FIG. 10A formed into an annular sleeve.

### DESCRIPTION OF THE PREFERRED EMBODIMENT

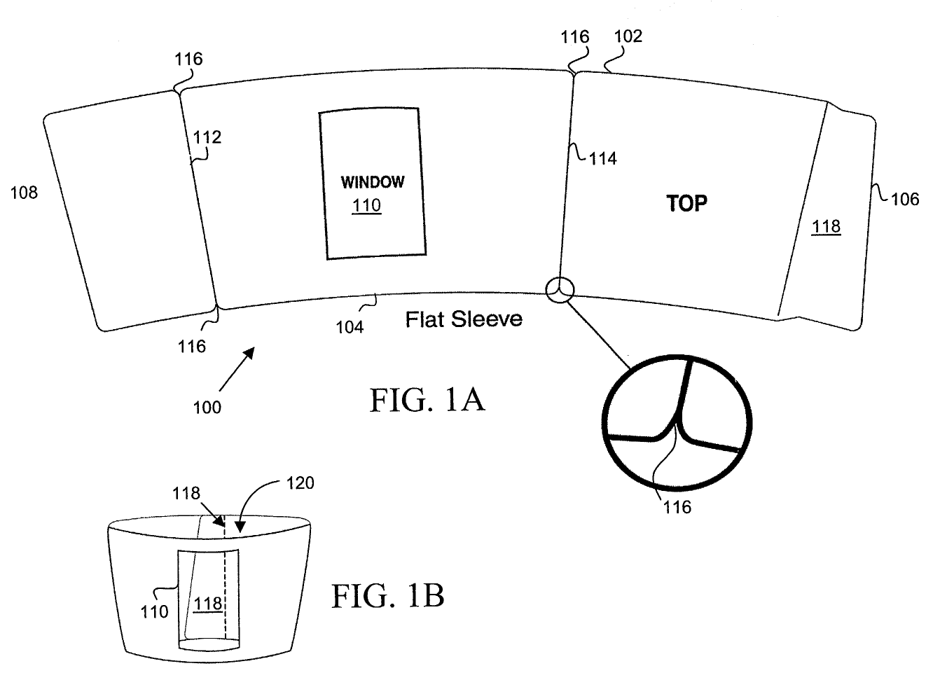

FIG. 1A illustrates an exemplary embodiment of a sleeve 100 according to the present invention. The sleeve 100 is preferably made of a firm material such as plastic. However, other materials may be utilized to construct the sleeve 100 such as paper, film, or any other material with a stiff or rigid quality, but which is still flexible. In one embodiment of the present invention, the sleeve 100 is manufactured flat and die-cut to a preferred size. Once die-cut, the sleeve 100 will be defined by a top edge 102, a bottom edge 104, a leading edge 106, and a trailing edge 108, and in the present embodiment, be curved in shape.

The sleeve 100 may be substantially non-transparent and have arranged thereon written indicia. The written indicia may include textual information, graphic information, and the like. According to one manufacturing technique, the indicia is printed on the sleeve 100 formed from a transparent material. Areas of the sleeve 100 which lie outside of the written indicia may then be printed with a background scheme or graphics which renders these areas opaque so as to obstruct viewing of any underlying indicia.

A transparent region 110 is further formed on the sleeve 100. The transparent region 110 may be formed of a substantially transparent material, or alternatively be die-cut from the sleeve 100. It should be noted that while only one transparent region 110 is depicted in FIG. 1A, a plurality of transparent regions may be used. As is discussed in further detail below, the transparent region 110 enables viewing of an underlying subset of indicia.

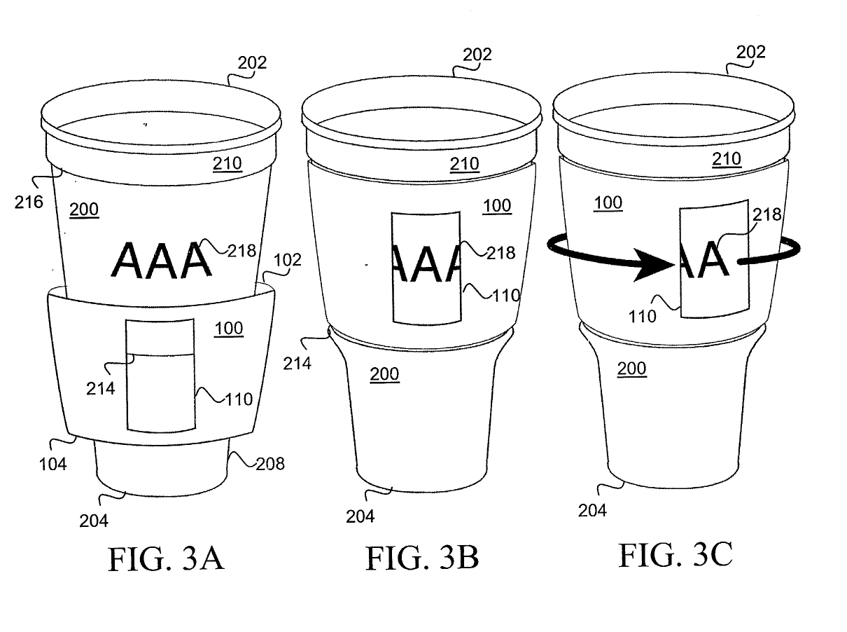

In the embodiment of FIG. 1A, the sleeve 100 is depicted as having a plurality of sections defined by fold lines 112 and 114. In alternative embodiments, the fold lines 112 and 114 may not exist. Towards the top edge 102 and bottom edge 104 of each fold line 112 and 114 is an expansion joint 116. Rounded corners of each expansion joint 116 provide the sleeve 100 with expansion ability to flex over surface contours of a container as will be described in more detail in conjunction with FIG. 3A. Alternatively, other variations of designs may be utilized to form the expansion joints 116.

Towards the leading edge 106 of the flat sleeve 100 is a flap section 118. The flap section 118 is preferably designed to overlap the trailing edge 108 in order to form a generally tubular shaped sleeve 100 as shown in FIG. 1B. The tubular shaped sleeve 100 may be formed by applying an adhesive to the leading edge 106, the trailing edge 108, the flap section 118, or any combination thereof. Alternatively, other methods of securing the leading and trailing edges 106 and 108 may be utilized depending on the material of the sleeve 100. For example, a heat source may be applied to a heat-sensitive, plastic leading edge 106 in order to make the leading edge 106 bondable to the trailing edge 108. In the embodiment of FIG. 1B, the annular sleeve 100 has a generally tapered shape with a circumference of the bottom edge 104 smaller than a circumference of the top edge 102.

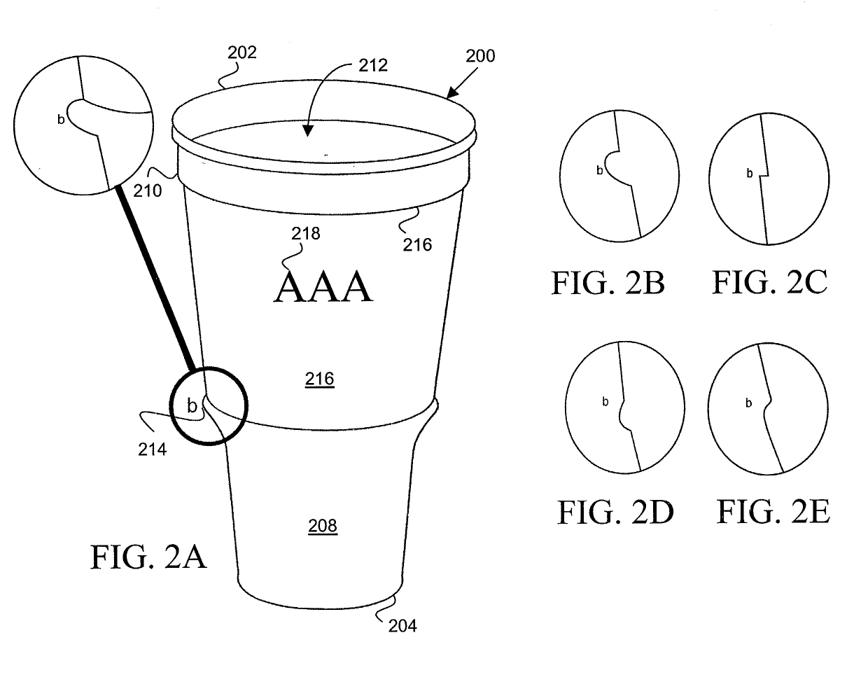

Referring now to FIG. 2A, an exemplary container 200 is shown. In the present embodiment, the container 200 is a drinking vessel. However, it should be noted that the container 200 may be of various designs and functions. The container 200 comprises a top end 202, a bottom end 204, a tapered section 206, and a lower section 208. Preferably, the container 200 is formed in a generally frusto-conical shape wherein the bottom end 204 is relatively narrow and expands upwardly and outwardly to the relatively wide top end 202. A top rim 210 is located on the top end 202 and defines an opening 212 through which contents of the container 200 may be placed into and taken out of the container 200. The container 200 may be formed from plastic, paper, or other materials which, preferably, are flexible.

The container 200 further includes a surface contour 214 for longitudinally maintaining the sleeve 100 (FIG. 1) about the container 200 as will be described in more detail below. In the embodiment of FIG. 2A, the surface contour 214 is shown as a raised ridge encircling a circumference of the container 200. The ridge is slightly rounded or tapered to allow the sleeve 100 to be slipped on or removed. Alternatively, other shapes for the surface contour 214 are contemplated by the present invention, and further exemplary embodiments are shown in FIGS. 2B-2E. FIGS. 2B, 2D, and 2E illustrate rounded forms of the surface contour 214 at various angles, while FIG. 2C shows a blunt surface contour 214.

Referring back to FIG. 2A, the tapered section 206 extends between a bottom edge 216 (which forms a surface contour) of the top rim 210 and the surface contour 214. Written indicia 218 is disposed on an exterior surface of the tapered section 214. Alternatively, the written indicia 218 may be disposed on a label (not shown) which is affixed to the exterior surface of the tapered section 214.

The lower section 208 of the container 200 preferably does not accommodate the sleeve 100. Thus, the lower section 208 may be utilized as a gripping area for a user. In order to facilitate gripping, the lower section 208 may be further disposed with a textured surface (not shown).

Referring now to FIG. 3A, a front view of the sleeve 100 partially advanced longitudinally over the lower section 208 of the container 200 is shown. Initially, the sleeve 100 is positioned about a central longitudinal axis of the container 200. Once the sleeve 100 is properly aligned with the container 200, the sleeve 100 is advanced upward over the lower section 208, and subsequently, over the surface contour 214. Because the circumference of the container 200 steadily expands outwardly from the bottom end 204 towards the top end 202, the sleeve 100 will easily advance over the lower section 208. However, when the sleeve 100 encounters the surface contours 214, the sleeve 100 must expand in order to advance over the surface contour 214. As previously discussed, the expansion joints 116 (FIG. 1A) provide expansion to allow the sleeve 100 to fit over the surface contour 214.

Once pass the surface contour 214, the sleeve 100 will continued to advance upward over the container 200 until the sleeve 100 encounters the bottom edge 216 of the top rim 210. Preferably, the top rim 210 is manufactured to a circumference which is greater than that of the annular sleeve 100. Thus, the sleeve 100 can not advance pass the top rim 210. Additionally, the sleeve 100 is of a height whereby the bottom edge 104 of the sleeve 100 is past the surface contour 214 when the top edge 102 encounters the top rim 210.

FIG. 3B shows a front view of the sleeve 100 fully disposed about the container 200. As shown. The sleeve 100 generally conforms about the container 200, and is held in position between the bottom edge 216 of the top rim 210 and the surface contour 214. Further, the size of the top rim 210 may be changed to allow for variations in the size of the sleeve 100 so that the sleeve 100 will not slide up too far on the container 200. The sleeve 100 may be further maintained about the container 200 by the downward taper of the container 200. In this embodiment, the taper of the container 200 prevents the sleeve 100 from moving upward because the diameter of the bottom edge 104 of the sleeve 100 is smaller than a diameter of the container 200 immediately above the bottom edge 104.

The sleeve 100 thus positioned about the container 200 generally obscures the view of the written indicia 218 located on the lower label or exterior surface of the container 200. However, this indicia 218 is viewable through the transparent region 110 of the sleeve 100. It should be noted that it is critical that certain underlying indicia 218 be viewable in its entirety through and be properly framed by the transparent region 110. Therefore, the transparent region 110 must be properly sized and positioned about the container 200.

FIG. 3C illustrates the sleeve system in use. As shown, the sleeve 100 is rotated relative its initial position depicted in FIG. 3B. As the sleeve 100 is rotated, the transparent region 110 allows a user to view the underlying subset of indicia 218 disposed on the inner label or container 200. The user selects the subset of indicia 218 to be viewed by rotating the sleeve 100 such that the selected subset of indicia 218 appears within the transparent region 110. Although FIG. 3C shows the sleeve 100 rotating in a counter-clockwise direction as viewed from the top of the container 200, the sleeve 100 may be rotated in the clockwise direction as well.

Although FIGS. 3A-3C illustrate one method of constructing a container 200 and sleeve 100 system, alternative methods are contemplated. For example, an automated method may provide an assembly line method whereby the containers are inverted (with the bottom end 204 positioned above the top end 202), so that the sleeve 100 may be slipped down onto the container 200. Alternatively, the sleeve 100 may be manufactured by wrapping the flat sleeve 100 around the container 200.

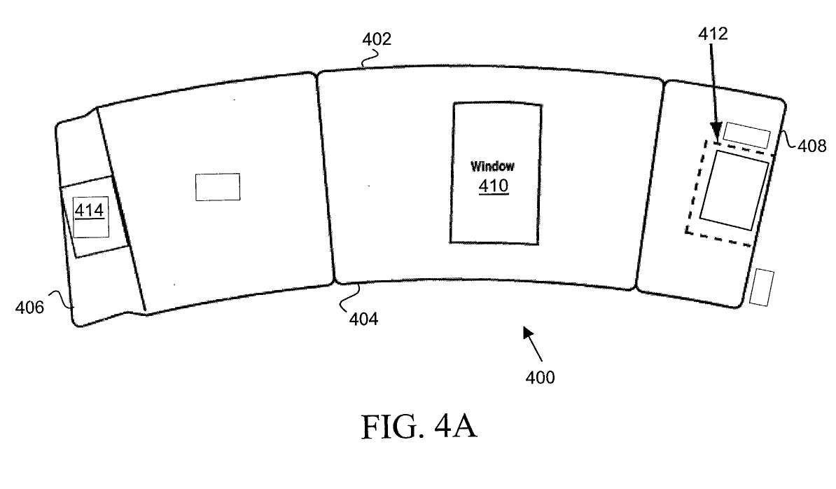

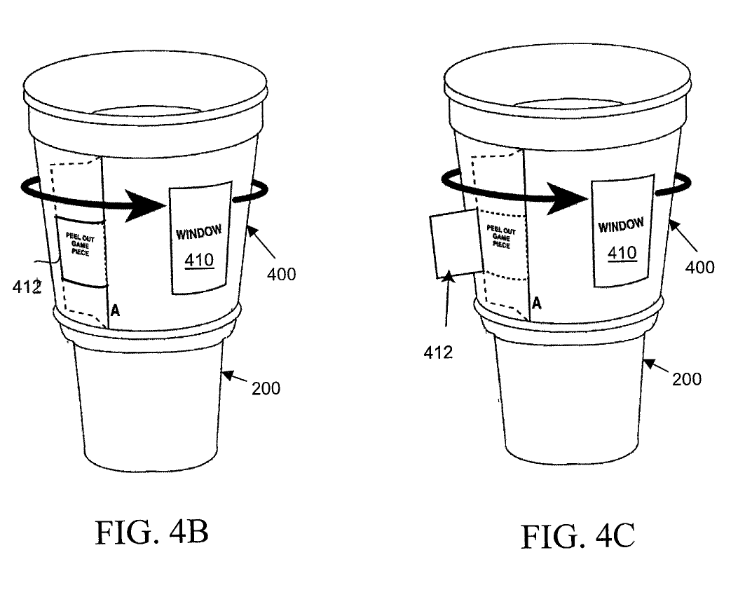

FIG. 4A illustrates an alternative embodiment of a sleeve 400. The sleeve 400 is similar to the embodiment of FIG. 1A, having a top edge 402, a bottom edge 404, a leading edge 406, a trailing edge 408, and a transparent region 410. However, the exemplary sleeve 400 further includes a peel out section 412 and an underlying section 414. Preferably the peel out section 412 is perforated so as to facilitate the remove of the peel out section 412 from the sleeve 400. The peel out section 412 may be a game piece containing a code or a redeemable coupon.

FIG. 4B shows the sleeve 400 disposed about the container 200. As with the embodiment of FIG. 3C, the sleeve 400 is rotatable about the container 200 so as to provide a user with the underlying subset of indicia through the transparent region 410. However, as shown in FIG. 4C, the peel out section 414 adds an extra element to the sleeve 400. Now, a user may remove the peel out section 414 which may contain a game piece.

Alternatively, the peel out section 412 may be positioned over the underlying section 414. In this embodiment, the underlying section 414 has indicia printed thereon. For example, this indicia will indicate to the user whether the user is a winner or loser of a contest. The underlying section 414 is hidden from view until the user removes the peel out section 412.

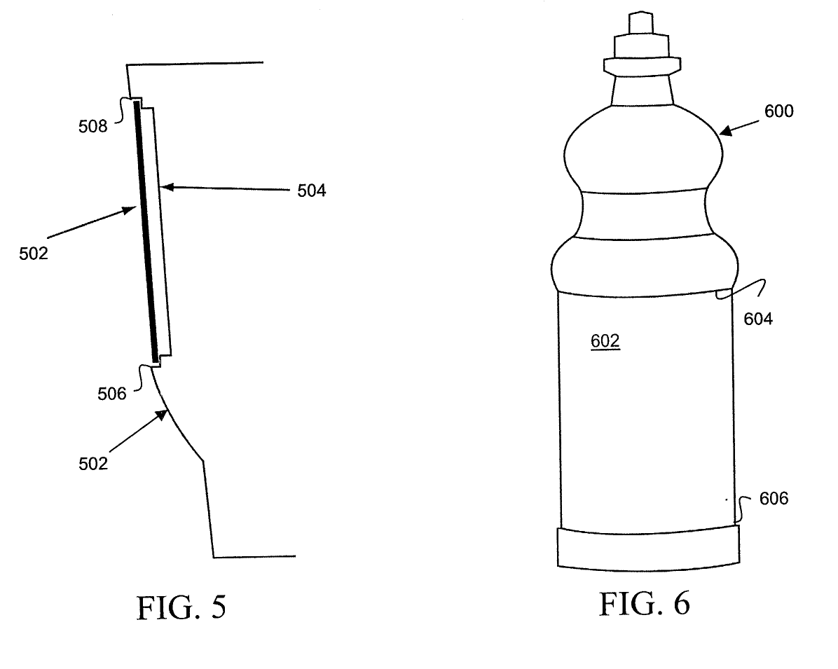

FIG. 5 is a side view of an alternative embodiment of a container 500 and sleeve 502 system according to the present invention. In this exemplary embodiment, the container 500 has a recessed wall 504 located underneath the sleeve 502. As shown, the recessed wall 504 is of a smaller height than a distance between a lower surface contour 506 and an upper surface contour 508 between which the sleeve 502 is held in position. This recessed wall 504 may have indicia disposed directly thereon or, alternatively, have an inner label affixed thereto. By having the recessed wall 504 and, thus, the inner label spaced from the sleeve 502, the inner label is protected from scuffing by the sleeve 502.

In a further embodiment of the present invention, the underlying indicia located on the recessed wall 504 may comprise combined masked images. Preferably at least two masked images (i.e., images having a spaced array of stripes comprising a viewable opaque portion with spaces positioned between and separating the stripes) are combined such that the viewable strips of a first image are positioned in the spaces of a second image (see U.S. Pat. No. 5,695,346 for additional details of this process). Further, a transparent region of the sleeve 502 may comprise a series of opaque (e.g., black) strips which block the first image while the second image is displayed, and vice-versa. Thus, only one of the images can be viewed from an angle of view at a time through the transparent region. By utilizing a recessed wall 504, sufficient spacing is provided between the sleeve 502 and the recessed wall 504 so that the angle of view may be changed without the rotation of the sleeve 502. The angle of view may be changed when a user moves relative to the container 500 and sleeve 502 system. For example, the container 500 and sleeve 502 system may be placed on a shelf. Merely moving from a right side of the shelf towards the left side of the shelf will change the angle of view enough to shift the series of opaque strips from over the first image to the second image, thus blocking the view of the second image while displaying the first image.

FIG. 6 illustrates an alternative embodiment of a container 600. In this embodiment, the container 600 has a straight-wall section 602 located between an upper surface contour 604 and a lower contour 606. Because the container 600 has a straight-wall section 602, a corresponding sleeve will also be of a generally uniform annular circumference. This sleeve is then held in position about the container 600 between the upper surface contour 604 and the lower contour 606.

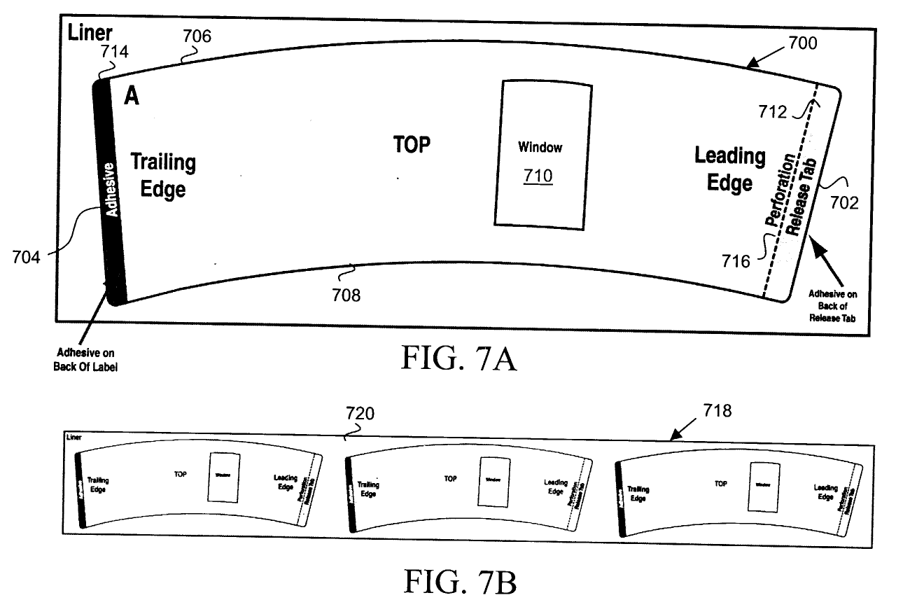

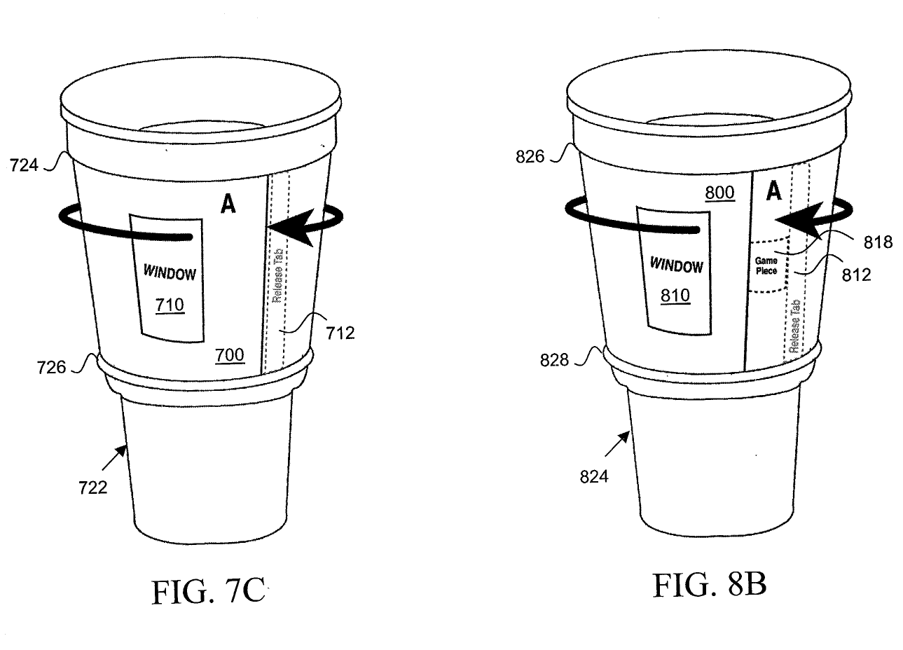

Referring now to FIG. 7A, an alternative embodiment of a sleeve or label 700 is illustrated. Similar to previous embodiments, the label 700 comprises a leading edge 702, a trailing edge 704, a top edge 706, a bottom edge 708, and a transparent region 710. However, the label 700 does not have expansion joints. Instead, the label 700 is preferably applied to a container in a “roll on” or “wrap-around” method as will be described in more detail in connection with FIG. 7C. The label 700 is further provided with a release tab 712 located adjacent to the leading edge 702 and an adhesive section 714 adjacent to the trailing edge 704. The release tab 712 preferably has an adhesive disposed on a back surface. Further, the release tab 712 may be detached from the rest of the label 700 along a perforation line 716.

For efficiency in producing the label 700 system, the label 700 may be provided on a roll 718 temporarily affixed to a liner 720 as illustrated in FIG. 7B. Such a roll of labels 700 can then be utilized in a machine-operated assembly line process to quickly and accurately apply labels 700 to a container.

FIG. 7C illustrates the label 700 disposed about a container 722. Initially, a portion or all of the label 700 is removed from the liner 720, and the release tab 712 is positioned on the container 722 between an upper surface contour 724 and a lower surface contour 726 of the container 722. Because the release tab 712 has adhesive disposed on the back surface, the label 700 is held in position against the container 722 while the label 700 is wrapped around the container 700. Eventually, the adhesive portion 714 extends pass the leading edge 702 and the release tab 712 to adhere the trailing edge 714 to the label 700 and secure the label 700 about the container 700. The label 700 is now removably attached to the container 700.

When a user desires to utilize the rotatable label 700 system for the first time, the user must separate the release tab 712 from the remainder of the label 700 along the perforation line 716. Preferably, the release tab 712 will remain attached to the container 722, while the remainder of the label 700 is free to rotate about the container 722.

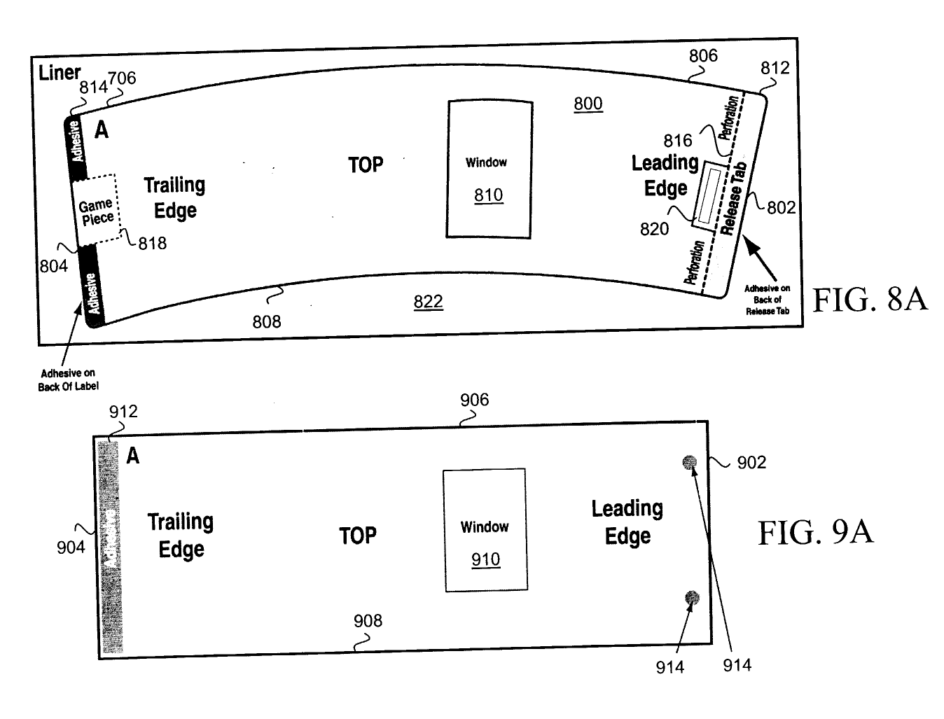

Referring now to FIG. 8A, another exemplary embodiment of a sleeve or label 800 is shown. The label 800 is similar to the embodiment of FIG. 7A having a leading edge 802, a trailing edge 804, a top edge 806, a bottom edge 808, and a transparent region 810. Similarly, the label 800 includes a release tab 812 located adjacent to the leading edge 802 and two adhesive sections $14 adjacent to the trailing edge 804. The release tab 812 has adhesive disposed on a back surface thereon, and may be detached from the rest of the label 800 along a perforation line 816. However, unlike the embodiment of FIG. 7A, the label 800 further includes a peel out section 818 and an underlying section 820. The peel out section 818 is positioned adjacent to the trailing edge 804 with the adhesive sections 814 located above and below the peel out section 818. Further, the peel out section 818 is perforated so as to facilitate the removal of the peel out section 818 from the label 800. The peel out section 818 may be a game piece containing a code or graphics printed on an underside of the peel out section 818 or located underneath the peel out section 818.

The label 800 is preferably provided on a roll (not shown) temporarily affixed to a liner 822. Such a roll of labels 800 may then be used on a machine-operated assembly line to expedite the labeling process. Initially, a portion or all of the label 800 is removed from the liner 822, and the release tab 812, with adhesive on the back surface is positioned on a container 824 of FIG. 8B between an upper surface contour 826 and a lower surface contour 828 on the container 824. The label 800 is then wrapped around the container 824 until the adhesive section 814 overlaps the leading edge 802 and extends over and beyond the release tab 812 to secure the label 800 about the container 800. Ideally, the peel out section 818 overlaps the underlying section 820. The label 800 is now removably attached to the contain 800.

As with the embodiment of FIG. 7C, the label 800 may be rotated about the container 824. However, the initial rotation will require that the release tab 812 be separated from the remainder of the label 800 along the perforation line 816. Further, a user may remove the peel out section 818 which may contain a game piece, or alternatively, the game piece may be located directly under the peel out section 818 on the underlying section 820.

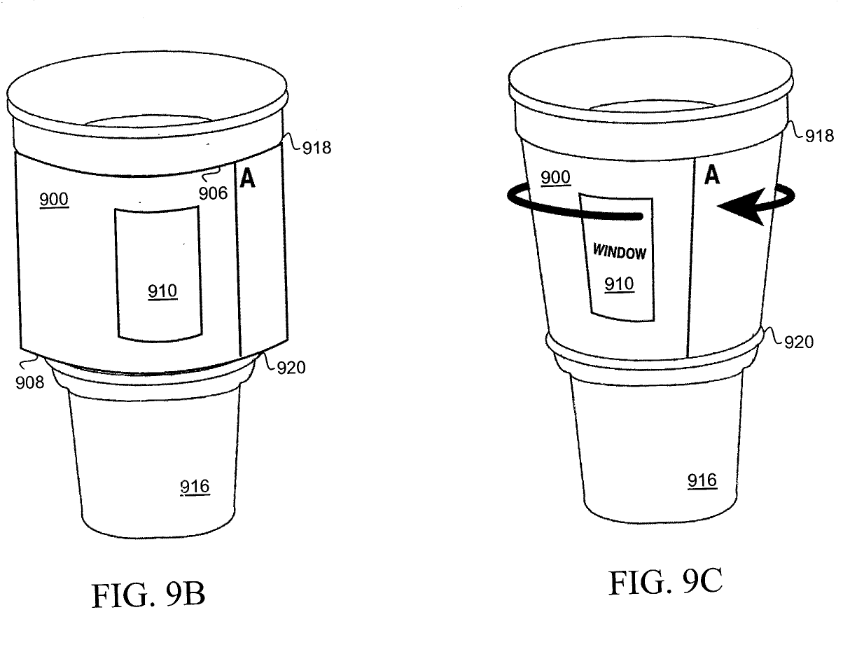

FIG. 9A is a front view of a further embodiment of a rotatable sleeve or label 900. The label 900 is defined by a leading edge 902, a trailing edge 904, a top edge 906, and a bottom edge 908. The label 900 also has at lease one transparent region 910. An adhesive 912 may be applied to the trailing edge 904 of the label 900. This adhesive 912 will enable the trailing edge 904 to become affixed to a front surface of the leading edge 902. Preferably, the exemplary label 900 of FIG. 9A is formed from a shrinkwrap-type material. Further, the shrinkwrap label 900 may be manufactured in a roll without a liner.

An optional temporary adhesive 914 may be applied near the leading edge 902. This temporary adhesive 914 preferably will hold the leading edge 902 of the label 900 to a container while the label 900 is wrapped around the container. Alternatively, other materials or methods may be used to temporarily hold the leading edge 902 to the container 900. The alternatives may include, for example, liquids, water, static electricity, pressure, vacuum, or air.

Referring now to FIG. 9B, the label 900 is shown disposed about a container 916. The label 900 is held in position by the temporary adhesive 914 or other temporary securing methods between an upper surface contour 918 and a lower surfaced contour 920. Further, the adhesive 912 adjacent to the trailing edge 904 adheres to the front surface of the leading edge 902. Heat is then applied to the shrinkwrap label 900 so that the label 900 conforms, generally, to the shape of the container 916 as shown in FIG. 9C. The temporary adhesive 914 is then broken or the alternative temporary securing method is then removed, thus allowing the label 900 to freely rotate about the container 916.

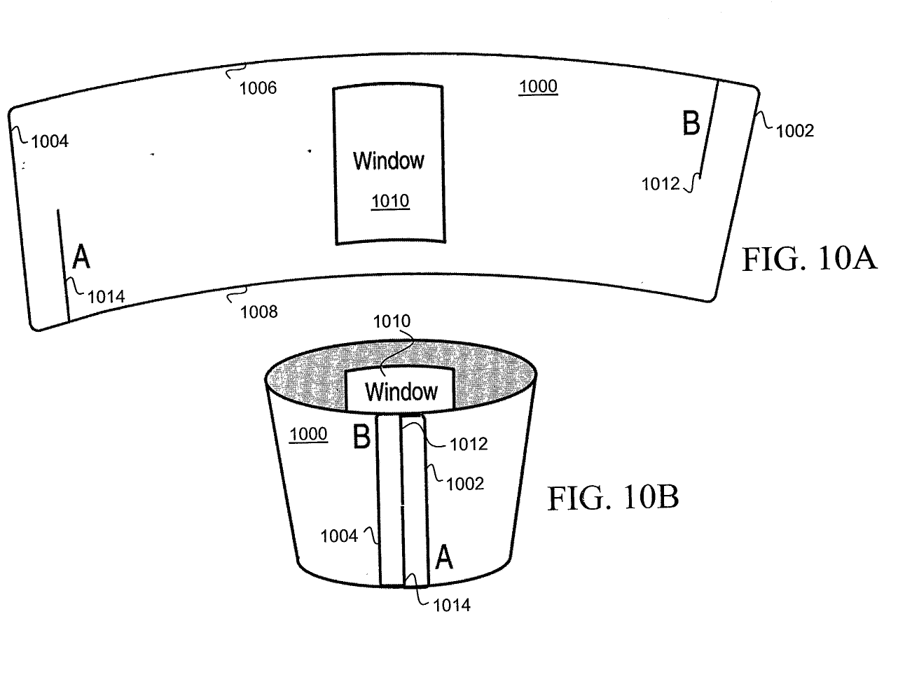

FIG. 10A is a front view of a further embodiment of a rotatable sleeve 1000 which does not utilize any adhesive. As shown the sleeve 1000 is curved in shape. Alternatively, the sleeve 1000 may be rectangular resulting in an untapered annular sleeve 1000. The sleeve 1000 is defined by a leading edge 1002, a trailing edge 1004, a top edge 1006, and a bottom edge 1008, and has at lease one transparent region 1010. The sleeve 1000 further comprises a first slit 1012 located near the leading edge 1002 and a second slit 1014 located near the trailing edge 1004. By interlocking the first slit 1012 with the second slit 1014, the sleeve 1000 forms an annular shape as shown in FIG. 10B. Subsequently, the sleeve 1000 may be applied to a container as previously described. It should be noted that the sleeve 1000 may be formed (e.g., die-cut) from any material which has a rigid, but flexible, quality such as plastic or paper. Further, indicia is applied to the sleeve 1000 in order to provide added information.

The invention has been described above with reference to exemplary embodiments. It will be apparent to those skilled in the art that various modifications may be made and other embodiments can be used without departing from the broader scope of the invention. Therefore, these and other variations upon the exemplary embodiments are intended to be covered by the present invention.

What is claimed is:

1. A rotatable sleeve device comprising:
a sleeve having a top edge and a bottom edge;
a transparent region formed in the sleeve; and
a plurality of expansion joints located along the top edge and bottom edge for providing expansion ability to the sleeve.

2. The rotatable sleeve device of claim 1 wherein the sleeve is formed of a material having a rigid quality.

3. The rotatable sleeve device of claim 2 wherein the sleeve if formed from plastic.

4. The rotatable sleeve device of claim 1 further comprising a flap section having adhesive for adhering the flap section to an opposing end of the sleeve to form an annular shape.

5. The rotatable sleeve device of claim 1 further comprising written indicia disposed thereon.

6. The rotatable sleeve device of claim 1 further comprising a peel out section which may be removed from the sleeve along perforation lines.

7. The rotatable sleeve device of claim 6 further comprising an underlying section located directly beneath the peel out section.

8. The rotatable sleeve device of claim 1 wherein the sleeve has a curved shaped resulting in a tapered annular shape.

9. A rotatable sleeve system comprising:
a object;
underlying indicia located on the object;
a sleeve device having a top edge and a bottom edge disposed about the object, the top edge and bottom edge further comprising expansion joints.

10. The rotatable sleeve system of claim 9 wherein the sleeve device further comprises a transparent region, the transparent region allowing the viewing of the underlying indicia.

11. The rotatable sleeve system of claim 10 wherein the transparent region has a series of opaque strips.

12. The rotatable sleeve system of claim 9 wherein the sleeve device further comprises a peel out section which may be removed from the sleeve along perforation lines.

13. The rotatable sleeve system of claim 9 wherein the object further comprises at least one surface contour, the at least one surface contour maintaining the sleeve about the object.

14. The rotatable sleeve system of claim 9 wherein the object further comprises a recessed wall.

15. The rotatable sleeve system of claim 9 wherein the object has a tapered shape and the sleeve device is tapered to correspond to the tapered shape of the object.

16. A rotatable sleeve device comprising:
a label having a leading edge and a trailing edge and being curved in shape;
a release tab adjacent to the leading edge; and
an adhesive section adjacent to the trailing edge for securing the trailing edge to a front surface adjacent to the release tab.

17. The rotatable sleeve device of claim 16 further comprising a transparent region.

18. The rotatable sleeve device of claim 16 wherein the label is provided on a liner.

19. The rotatable sleeve device of claim 16 wherein the label is provided in a roll of labels.

20. The rotatable sleeve device of claim 16 further comprising indicia disposed on the label.

21. The rotatable sleeve device of claim 16 further comprising a peel out section located near the trailing edge.

22. A rotatable sleeve device comprising:
a label formed from a heat shrinkable material and having a leading edge and a trailing edge;
a temporary adhesive disposed near a leading edge for temporarily securing the leading edge to a container; and
adhesive disposed adjacent to the trailing edge for adhering the trailing edge to a front surface near the leading edge.

23. The rotatable sleeve device of claim 22 further comprising a transparent region.

24. The rotatable sleeve device of claim 22 further comprising indicia disposed on the label.

25. The rotatable sleeve device of claim 22 wherein the temporary adhesive is a liquid.

26. The rotatable sleeve device of claim 22 wherein the temporary adhesive is pressure.

27. The rotatable sleeve device of claim 22 wherein the temporary adhesive is air.

28 A method for disposing a rotatable sleeve device about an object, comprising the steps of:
providing an object having at least one surface contour;
applying underlying indicia to the object;
providing an annular shaped sleeve device having expansion joints;
advancing the sleeve device longitudinally over the object; and
expanding the expansion joints to accommodate the sleeve over the at least one surface contour.

29. The method of claim 28 wherein the underlying indicia is disposed directly to an exterior surface of the object.

30. The method of claim 28 wherein the underlying indicia is disposed on an inner label affixed to the object.

31. The method of claim 28 wherein the step of providing a sleeve further comprises the step of providing a transparent region on the sleeve, the transparent region allowing viewing of the underlying indicia.

32. The method of claim 28 wherein the step of providing the sleeve further comprises the step of disposing indicia on the sleeve.

33. A method for applying a rotatable sleeve to an object, comprising the steps of:
removing a leading edge of a label from a liner;
applying a release tab portion adjacent to the leading edge to an object;
wrapping the label around the object; and
adhering a trailing edge of the label to a front surface of the label adjacent to the release tab.

34. The method of claim 33 wherein the label is provided from a roll of labels.

35. A method for applying a rotatable sleeve device to an object, comprising the steps of:
temporarily coupling a leading edge of a label of a heat-shrinkable material to an object;
wrapping the label around the object;
adhering a trailing edge of the label to a front surface of the label adjacent to the leading edge;
applying heat to the label such that the label generally conforms to the object; and
uncoupling the leading edge to permit the label to rotate about the object.

36. A rotatable sleeve system comprising:
means for removing a leading edge of a label from a liner;
means for applying a release tab portion adjacent to the leading edge to an object;
means for wrapping the label around the object; and
means for adhering a trailing edge of the label to a front surface of the label adjacent to the release tab.

37. A rotatable sleeve system comprising:
means for temporarily coupling a leading edge of a label of a heat-shrinkable material to an object;
means for wrapping the label around the object;
means for adhering a trailing edge of the label to a front surface of the label adjacent to the leading edge;
means for applying heat to the label such that the label generally conforms to the object; and
means for uncoupling the leading edge to permit the label to rotate about the object.

38. A rotatable sleeve system comprising:
means for providing an object having at least one surface contour;
means for applying underlying indicia to the object;
means for providing an annular shaped sleeve device having expansion joints;
means for advancing the sleeve device longitudinally over the object; and
means for expanding the expansion joints to accommodate the sleeve over the at least one surface contour.

39. A rotatable sleeve device comprising:
a sleeve having a leading edge and a trailing edge;
a transparent region formed in the sleeve;
a first slit located near the leading edge; and
a second slit located near the trailing edge, the first slit interlocking with the second slit in order to shape the sleeve into an annular form.

40. The rotatable sleeve device of claim 39 further comprising written indicia disposed thereon.

41. The rotatable sleeve device of claim 39 wherein the sleeve has a curved shaped resulting in the annular form being tapered.
